(19) United States
(12) Patent Application Publication
(10) Pub. No.: US 2022/0151875 A1
(43) Pub. Date: May 19, 2022

(54) DRUG MIXING DEVICE, DRUG MIXING KIT COMPRISING THE SAME, AND METHOD OF MANUFACTURING THE SAME

(71) Applicant: Yong Hyun Kim, Gyeonggi-do (KR)

(72) Inventor: Yong Hyun Kim, Gyeonggi-do (KR)

(21) Appl. No.: 17/435,585

(22) PCT Filed: Mar. 3, 2020
(86) PCT No.: PCT/KR2020/002986

§ 371 Date: Sep. 1, 2021

(30) Foreign Application Priority Data
Mar. 5, 2019 (KR) 10-2019-0025413

(51) Int. Cl. A61J 1/20; B01F 23/451; B01F 23/40; B01F 23/50; B01F 35/00; B01F 35/71; B01F 25/312; A61J 1/14; A61J 1/16

(52) U.S. Cl. CPC A61J 1/2096; B01F 2101/22; B01F 23/49; B01F 23/59; B01F 23/56; B01F 35/165; B01F 35/7161; B01F 35/7163; B01F 35/7174; B01F 25/312; A61J 1/2089; A61J 1/2037; A61J 1/201; A61J 1/1406; A61J 1/16; B01F 23/451

(57) ABSTRACT

In drug mixing devices of disclosed embodiments, a main flow path extending from one end configured to allow liquid inside the first container to enter the main flow path therethrough to another end configured to allow liquid inside the second container to enter the main flow path therethrough, and a branch flow path branching from the main flow path are formed. The drug mixing device includes a body including a first connection part configured to be coupled with the first container and a second connection part configured to be coupled with the second container, and a backflow prevention part disposed in a partial flow path of the main flow path extending to the one end with reference to the connection point of the main flow path and the branch flow path, the backflow prevention part being configured to prevent liquid from flowing from the connection point to the one end.

### TECHNICAL FIELD

The present disclosure relates to a drug mixing device, a drug mixing kit, and a method of manufacturing the same.

### BACKGROUND

In the medical field, a mixed drug in a liquid form may be injected into a patient by mixing a liquid or powder form, such as an analgesic, antibiotic, or anticancer drug, with another drug in a liquid form, a medical liquid, or a distilled water. An example of a method of mixing drugs in the related art is as follows. A container, such as a bag or vial containing a drug in a liquid form, a medical liquid, or a distilled water, is punctured by piercing the container with an injection needle of a syringe, the content inside the container is sucked into and accommodated in the syringe, and the injection needle is withdrawn from the container. Then, another container containing a drug in a liquid or powder form is punctured by piercing the other container with the injection needle of the syringe, the drug in the liquid form, the medical liquid or the distilled water inside the syringe is injected into the other container, and then the other container is shaken to mix the contents therein. After the mixing is completed, the mixed solution in the other container is sucked into the syringe through the injection needle to be accommodated in the syringe, and then the injection needle is withdrawn from the other container.

### SUMMARY

In the related art, in order to mix the contents in two containers with each other, there is a problem in that it is necessary to sequentially pierce the two containers with an injection needle of a syringe and to withdraw the injection needle of the syringe. Due to a complicated manual work in an urgent medical field, there is a problem in that the probability that the injection needle of the syringe is contaminated by external contaminants or pathogens increases and that the probability of an accident in which the injection needle touches the skin of medical staff increases. This is a very serious problem as it may have a significant adverse effect on the health of a patient and medical staff. Embodiments of the present disclosure solve the problems of the related art described above.

In the case of using an expensive sterilization facility in order to prevent the above-described problems in the related art, there is a problem that it is difficult to use such a sterilization facility in an emergency situation in the medical field while incurring a high cost. Embodiments of the present disclosure solve the problems described above.

An aspect of the present disclosure provides embodiments of a drug mixing device for mixing a first content in a liquid form in a first container and a second content in a liquid or powder form in a second container. In the drug mixing device according to a representative embodiment, a main flow path extending from one end configured to allow a liquid inside the first container to flow into the main flow path therethrough to other end configured to allow a liquid inside the second container to flow into the main flow path therethrough, and a branch flow path branching from the main flow path are formed. The main flow path includes, with reference to a connection point of the main flow path and the branch flow path, a first flow path extending while connecting the one end to the connection point and a second flow path extending while connecting the other end to the connection point. The drug mixing device includes a body including a first connection part configured to be coupled with the first container and a second connection part configured to be coupled with the second container, and a backflow prevention part disposed in a partial flow path of the main flow path extending in a direction of the one end with reference to the connection point of the main flow path and the branch flow path, the backflow prevention part being configured to prevent the liquid from flowing from the connection point to the one end while allowing the liquid to flow from the one end to the connection point. In a state in which the first container, the second container, and a syringe including an inner space communicating with the branch flow path are coupled to the drug mixing device, the first content in the first container flows into the inner space via the first flow path and the branch flow path and then the first content in the inner space flows into the second container via the branch flow path and the second flow path to allow the first content in the first container to flow into the second container. When the first content flows into the inner space, the pressure inside the first container and the pressure inside the second container are lowered.

In the embodiments, the first connection part may include a plurality of hooks configured to be engaged with the first container. The second connection part may include a plurality of hooks configured to be engaged with the second container. The body may include a support part configured to support the first connection part and the second connection part.

In the embodiments, the drug mixing device may further include a first needle forming a side of the one end of the main flow path and protruding to be insertable into an interior of the first container, and a second needle forming a side of the other end of the main flow path and protruding to be insertable into an interior of the second container. The plurality of hooks of the first connection part may be arranged to be spaced apart from each other in the circumferential direction around the first needle. The plurality of hooks of the second connection part may be arranged to be spaced apart from each other in the circumferential direction around the second needle.

In the embodiments, the body may further include a branch portion forming at least a portion of the branch flow path configured to discharge the liquid into the syringe.

In the embodiments, the body may further include a branch portion configured to be connectable to the syringe that defines therein the inner space communicating with the branch flow path.

In the embodiments, the drug mixing device may further include a first needle forming a side of the one end of the main flow path and protruding to be insertable into an interior of the first container, and a second needle forming a side of the other end of the main flow path and protruding to be insertable into an interior of the second container.

In the embodiments, the first needle and the second needle may be fixed to the body.

In the embodiments, the body may include a first part in which the backflow prevention part is disposed with the first needle being fixed to the first part, and a second part coupled to the first part while covering the backflow prevention part with the second needle being fixed to the second part.

In the embodiments, at least one needle of the first needle and the second needle may define therein a remaining amount inflow hole in a side surface at a position spaced apart from a pointed end thereof. The drug mixing device may be configured to enable the liquid to flow into the main flow path from an interior of the container, into which the at least one needle is inserted, through the remaining amount inflow hole.

In the embodiments, the drug mixing device may further include a sealer disposed in the branch flow path and configured to be penetrated by a needle of the syringe.

In the embodiments, the drug mixing device may further include a supporter coupled to the body and configured to support the syringe.

Another aspect of the present disclosure provides embodiments of a method for manufacturing a drug mixing device. The method of manufacturing a drug mixing device according to a representative embodiment includes fixing the first connection part and the second connection part to the support part.

Still another aspect of the present disclosure provides embodiments of a drug mixing kit for mixing a first content in a liquid form in a first container and a second content in a liquid or powder form in a second container. A drug mixing kit according to a representative embodiment includes: a drug mixing device in which a main flow path extending from one end configured to allow a liquid inside the first container to flow into the main flow path therethrough to other end configured to allow a liquid inside the second container to flow into the main flow path therethrough and a branch flow path branching from the main flow path are formed; and a syringe coupled to the drug mixing device and including an inner space communicating with the branch flow path, the syringe being configured to suck a liquid from the branch flow path into the inner space and discharge the liquid from the inner space into the branch flow path. The main flow path includes, with reference to a connection point of the main flow path and the branch flow path, a first flow path extending while connecting the one end to the connection point and a second flow path extending while connecting the other end to the connection point. The drug mixing device includes a body including a first connection part configured to be coupled with the first container and a second connection part configured to be coupled with the second container, and a backflow prevention part disposed in a partial flow path of the main flow path extending in a direction of the one end with reference to the connection point of the main flow path and the branch flow path, the backflow prevention part being configured to prevent the liquid from flowing from the connection point to the one end while allowing the liquid to flow from the one end to the connection point. In a state in which the syringe, the first container, and the second container are coupled to the drug mixing device, the first content in the first container is caused to flow into the inner space via the first flow path and the branch flow path by increasing a volume of the inner space and then the first content in the inner space is caused to flow into the second container via the branch flow path and the second flow path by decreasing the volume of the inner space to allow the first content in the first container to flow into the second container. When the first content flows into the inner space, the pressure inside the first container and the pressure inside the second container are lowered.

In the embodiments, the drug mixing device and the syringe may be detachably coupled to each other.

In the embodiments, the drug mixing device may further include a sealer disposed in the branch flow path. The syringe may include a syringe needle configured to penetrate the sealer and define therein a flow path to guide a flow of the liquid between the branch flow path and the inner space.

According to the embodiments of the present disclosure, it is possible to significantly reduce the probability that a component inserted into a patient, such as an injection needle, or a drug administered to the patient is contaminated from external contamination sources or pathogens.

According to the embodiments of the present disclosure, it is possible for medical staff to mix drugs in a very simple and efficient manner.

According to the embodiments of the present disclosure, it is possible to quickly and safely mix drugs.

### BRIEF DESCRIPTION OF THE DRAWINGS

FIG. 1 is a perspective view illustrating the state in which a first container 6 and a second container 7 are coupled to a drug mixing kit 1 according to a first embodiment of the present disclosure.

FIG. 2 is an exploded perspective view illustrating the drug mixing kit 1, the first container 6, and the second container 7 of FIG. 1.

FIG. 3 is a partial vertical cross-sectional view illustrating the drug mixing kit 1, the first container 6, and the second container 7 of FIG. 1, taken along the line S1-S1′.

FIGS. 4A to 4F are vertical cross-sectional views illustrating a drug mixing device 100, a syringe 200, the first container 6, and/or the second container 7 taken along line S1-S1′ in FIG. 1 and sequentially showing an example of using the drug mixing kit 1 of FIG. 1.

FIG. 5 is a perspective view illustrating the state in which a first container 6 and a second container 7 are coupled to a drug mixing kit 1′ according to a second embodiment of the present disclosure.

FIG. 6 is an exploded perspective view illustrating the drug mixing kit 1′, the first container 6, and the second container 7 of FIG. 5.

FIG. 7 is a partial vertical cross-sectional view illustrating the drug mixing kit 1′, the first container 6, and the second container 7 of FIG. 5.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical and scientific terms used in the present disclosure have the meaning generally understood by those of ordinary skill in the art to which the present disclosure pertains, unless otherwise defined. All terms used in the present disclosure are chosen for the purpose of more clearly describing the present disclosure and are not chosen to limit the scope of rights according to the present disclosure.

As used in this disclosure, expressions such as “comprising”, “including”, “having”, and the like are to be understood as open-ended terms having the possibility of encompassing other embodiments, unless otherwise mentioned in the phrase or sentence containing such expressions.

The singular form used in the present disclosure may include a plural meaning unless otherwise mentioned. This applies to the singular form recited in the claims.

Terms such as “first” and “second” used in the present disclosure are used in order to distinguish a plurality of components from one another, and do not limit the order or importance of the corresponding components.

In the present disclosure, where it is mentioned in the present disclosure that one element is “connected” to another element, it is to be understood that the one element may be directly connected to the another element, or may be connected to the another element via a new additional element.

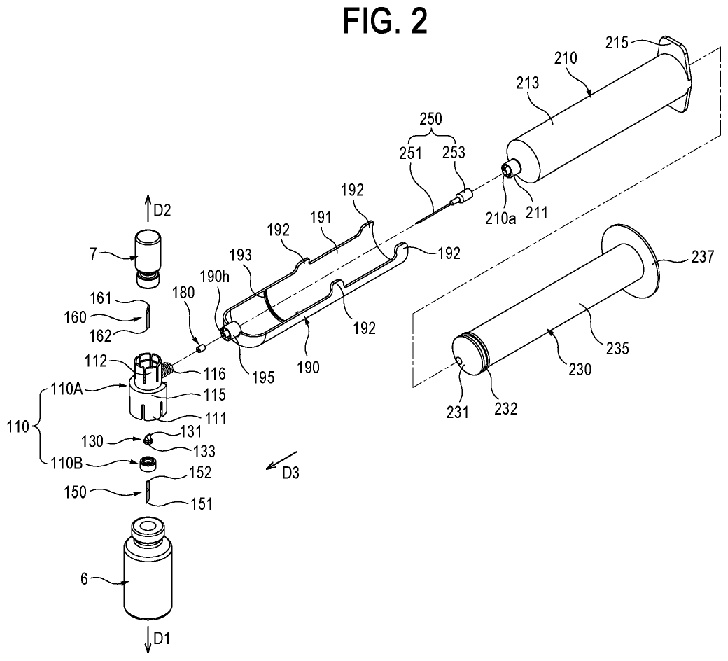

As used in the present disclosure, the term “first direction” means a direction in which a drug mixing device moves when the drug mixing device is brought close to a first container such that the drug mixing device and the first container are coupled to each other, and the term “second direction” means a direction in which the drug mixing device moves when the drug mixing device is brought close to a second container such that the drug mixing device and the second container are coupled to each other. As used in the present disclosure, the “third direction” means a direction in which a syringe moves when the syringe is brought close to the drug mixing device such that the drug mixing device and the syringe are coupled to each other. FIGS. 2, 3, 6, and 7 illustrate a first direction D1, a second direction D2, and a third direction D3, but each direction is not limited to the embodiments of the present disclosure.

Hereinafter, embodiments of the present disclosure will be described with reference to the accompanying drawings. In the accompanying drawings, like or relevant components are indicated by like reference numerals. In the following description of embodiments, repeated descriptions of the identical or relevant components will be omitted. However, even if a description of a component is omitted, such a component is not intended to be excluded in an embodiment.

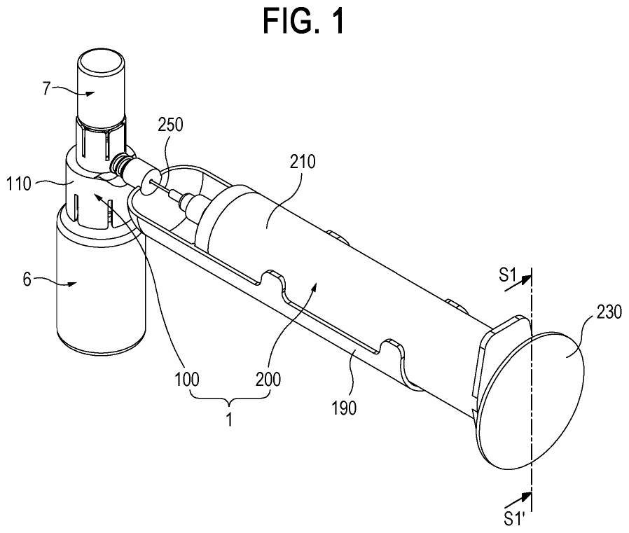

FIG. 1 is a perspective view illustrating a state in which a first container 6 and a second container 7 are coupled to a drug mixing kit 1 according to a first embodiment of the present disclosure. Referring to FIG. 1, a user (e.g., medical staff such as a nurse or a doctor) may couple the first container 6 and the second container 7 to the drug mixing kit 1. The drug mixing kit 1 is configured to mix a first content in a liquid form in the first container 6 and a second content in a liquid or powder form in the second container 7.

The user may mix the first content with the second content using the drug mixing kit 1, and cause the mixture in which the first content and the second content are mixed to flow into the syringe 200. For example, the first content, such as a medical liquid, and the second content, which is a drug in a powder form, may be mixed. As another example, the first content, which is a drug in a liquid form, and the second content, which is another drug in a liquid form, may be mixed.

The drug mixing kit 1 includes a drug mixing device 100 and a syringe 200 coupled to the drug mixing device 100. The drug mixing device 100 and the syringe 200 may be detachably coupled to each other. The user may mix the first content with the second content using the drug mixing kit 1, and may separate the syringe 200 from the drug mixing device 100 after the mixture is filled in the syringe 200.

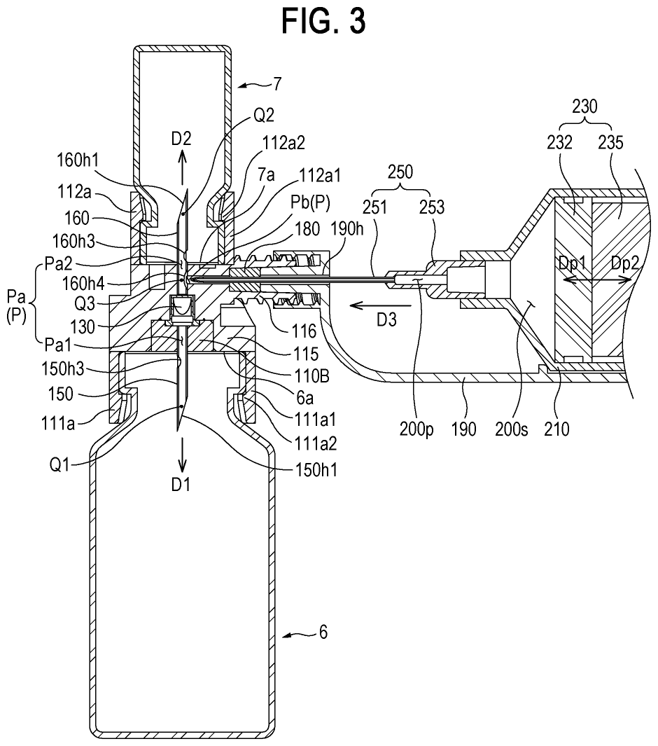

FIG. 2 is an exploded perspective view illustrating the drug mixing kit 1, the first container 6, and the second container 7 of FIG. 1. FIG. 3 is a partial vertical cross-sectional view illustrating the drug mixing kit 1, the first container 6, and the second container 7 of FIG. 1, taken along line S1-S1′.

Referring to FIGS. 2 and 3, the drug mixing device 100 includes a flow path P configured to guide a flow of a liquid. The flow path P includes a main flow path Pa and a branch flow path Pb.

In the present embodiment, the main flow path Pa may extend in a straight line, but according to an embodiment, the main flow path Pa may be bent or curved in some sections. In the present embodiment, the branch flow path Pb may extend in a straight line in a direction opposite to the third direction D3, but according to an embodiment, some sections of the branch flow path may be bent or curved. In addition, some components of the drug mixing device 100 may form at least a part of the main flow path Pa and/or the branch flow path Pb, which is not limited to the embodiments of the present disclosure.

In the drug mixing device 100, the main flow path Pa extends from one end Q1 configured to allow the liquid inside the first container 6 to flow into the main flow path Pa therethrough to the other end Q2 configured to allow the liquid inside the second container 7 to flow into the main flow path Pa therethrough. The main flow path Pa is located in the drug mixing device 100. For example, the first content in a liquid form in the first container 6 may flow into the main flow path Pa, and the mixture in a liquid form in the second container 7 may flow into the main flow path Pa.

The one end Q1 of the main flow path Pa is disposed on the first container 6 side. The other end Q2 of the main flow path Pa is disposed on the second container 7 side. The one end Q1 is located at the distal end in the first direction D1 of the main flow path Pa. The other end Q2 is located at the distal end in the second direction D2 of the main flow path Pa.

The main flow path Pa includes a first flow path Pa1 and a second flow path Pa2. The first flow path Pa1 and the second flow path Pa2 are divided with reference to a connection point Q3 of the main flow path Pa and the branch flow path Pb. The first flow path Pa1 extends while connecting the one end Q1 and the connection point Q3 to each other. The second flow path Pa2 extends while connecting the other end Q2 and the connection point Q3 to each other. The first flow path Pa1 includes a portion extending in the first direction D1. The second flow path Pa2 includes a portion extending in the second direction D2.

In the drug mixing device 100, a branch flow path Pb branches from the main flow path Pa. The branch flow path Pb includes a portion extending in the third direction D3. The branch flow path Pb is located in the drug mixing device 100. In the embodiment of the drug mixing device 100 separated from the syringe 200, the branch flow path Pb may be blocked by a sealer 180. In the embodiment of the drug mixing kit 1 in which the syringe 200 and the drug mixing device 100 are coupled to each other, the branch flow path Pb may be opened by a syringe needle 250 penetrating the sealer 180.

At least a portion of the syringe needle 250 of the syringe 200 may be inserted into the branch flow path Pb of the drug mixing device 100. In this case, the liquid may flow along the flow path inside the syringe needle 250 disposed in the branch flow path Pb. The syringe needle 250 is inserted into the branch flow path Pb in the third direction D3.

The drug mixing device 100 includes a body 110. At least a portion of the flow path P may be formed in the body 110. The main flow path Pa may penetrate the body 110. A portion of the first flow path Pa1 and a portion of the second flow path Pa2 may be formed in the body 110. The branch flow path Pb may be formed in the body 110.

The body 110 may be configured to be coupled with the first container 6 and the second container 7. The body 110 includes a first connection part 111 configured to be coupled with the first container 6 and a second connection part 112 configured to be coupled with the second container 7. The body 110 includes a support part 115 configured to support the first connection part 111 and the second connection part 112. The body 110 includes a branch portion 116 that defines therein at least a portion of the branch flow path Pb.

The body 110 may include a first part 110A and a second part 110B coupled to each other. The first part 110A and the second part 110B may be coupled to each other through a method such as laser bonding or ultrasonic bonding. The second part 110B may be coupled to a side surface in the first direction D1 of the first part 110A. The main flow path Pa may penetrate the first part 110A and the second part 110B.

The first part 110A may include the first connection part 111, the second connection part 112, the support part 115, and the branch portion 116. A first needle 150 may be fixed to the first part 110A. A second needle 160 may be fixed to the second part 110B. In the present embodiment, the first needle 150 and the second needle 160 are manufactured as separate members from the body 110 and fixed to the body 110. In another embodiment not illustrated, the first needle 150 and the second needle 160 are integrally molded with all or part of the body 110 so that the first needle 150 and the second needle 160 can be fixed to the body 110.

A backflow prevention part 130 may be disposed in the first part 110A. The second part 110B may be coupled to the first part 110A while covering the backflow prevention part 130. The backflow prevention part 130 is disposed between the first part 110A and the second part 110B. A groove is formed in one side surface of the first part 110A, and the backflow prevention part 130 is inserted into the groove in the first part 110A. The groove in the first part 110A defines therein a portion of the first flow path Pa1.

In the present embodiment, the first connection part 111 and the second connection part 112 are configured to be hook-coupled with the first container 6 and the second container 7, respectively. However, in another embodiment (not illustrated), the first connection part and/or the second connection part may be configured to be coupled to a corresponding container (the first container and/or the second container) in another manner such as screwing.

In an embodiment, the first connection part 111 includes a plurality of hooks 111a configured to be engaged with the first container 6. In the state in which the first container 6 is coupled to the drug mixing device 100, the plurality of hooks 111a may be arranged to be spaced apart from each other in the circumferential direction around the position of the first container 6. The plurality of hooks 111a may be arranged to be spaced apart from each other in the circumferential direction around the first needle 150. Each hook 111a includes a hook extension 111a1 extending in the first direction D1 from the support part 115, and an engagement protrusion 111a2 protruding from the distal end in the first direction D1 of the hook extension 111a1 toward a center (in the direction facing the first needle).

In an embodiment, the second connection part 112 includes a plurality of hooks 112a configured to be engaged with the second container 7. In the state in which the second container 7 is coupled to the drug mixing device 100, the plurality of hooks 112a may be arranged to be spaced apart from each other in the circumferential direction around the position of the second container 7. The plurality of hooks 112a may be arranged to be spaced apart from each other in the circumferential direction around the second needle 160. Each hook 112a includes a hook extension 112a1 extending in the second direction D2 from the support part 115, and an engagement protrusion 112a2 protruding from the distal end in the second direction D2 of the hook extension 112a1 toward a center (in the direction facing the second needle).

The support part 115 may form at least a portion of the main flow path Pa. The backflow prevention part 130 may be disposed in the support part 115. The support part 115 may constitute at least a portion of the first part 110A. The second part 110B may be coupled to the support part 115.

The support part 115, the first connection part 111, and the second connection part 112 may be integrally formed through a method such as injection molding or the like. However, in the present embodiment, the first connection part 111 and the second connection part 112 are attached to the support part 115. That is, the body 110 may be formed through a method of fixing the first connection part 111 and the second connection part 112 to the support part 115.

The branch portion 116 defines therein at least a portion of the branch flow path Pb configured to be capable of discharging the liquid into the syringe 200. In the first embodiment, in the state in which the sealer 180 is penetrated by the syringe needle 250, the liquid may flow through the branch flow path Pb.

The branch portion 116 may protrude from the support part 115 in a direction opposite to the third direction D3. The distal end of the branch flow path Pb is disposed on a side surface in a direction opposite to the third direction D3 of the branch portion 116. A screw may be formed in the branch portion 116. In the first embodiment, the screw formed on the outer circumferential surface of the branch portion 116 and a supporter 190 are fastened to each other.

The branch portion 116 is configured to enable the syringe 200, which defines therein an inner space 200s communicating with the branch flow path Pb, to be connected thereto. In the present embodiment, the branch portion 116 is connected to the syringe 200 via the sealer 180.

The drug mixing device 100 includes a backflow prevention part (a one-way valve) 130 disposed in the flow path P. The backflow prevention part 130 is disposed in the first flow path Pa1 extending toward a side of one end Q1 with reference to the connection point Q3. The backflow prevention part 130 is configured to substantially prevent a flow of the liquid from the connection point Q3 to the side of the one end Q1.

The backflow prevention part 130 implements the function of a check valve (a one-way valve). The backflow prevention part 130 may allow the flow (inflow) of the liquid moving from the one end Q1 to the connection point Q3, but may block the flow (outflow) of the liquid moving from the connection point Q3 to the one end Q1. Various types of backflow prevention parts capable of implementing the function of a check valve may be configured.

In the present embodiment, the backflow prevention part 130 includes a protrusion 131 protruding in the inflow direction. The protrusion 131 is formed of a flexible material.

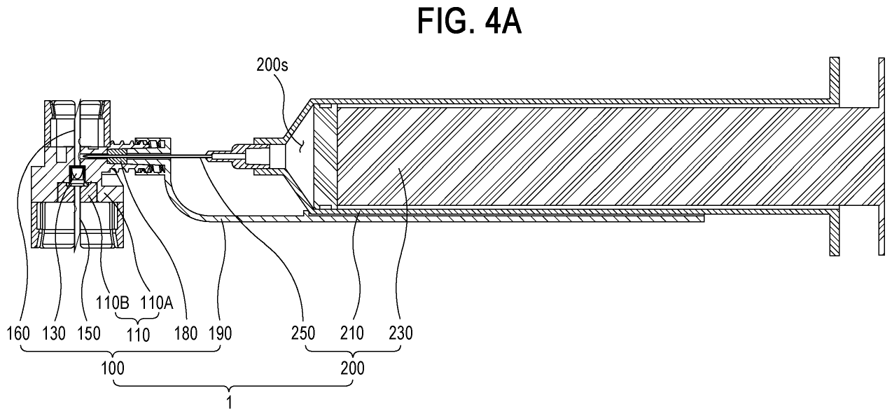

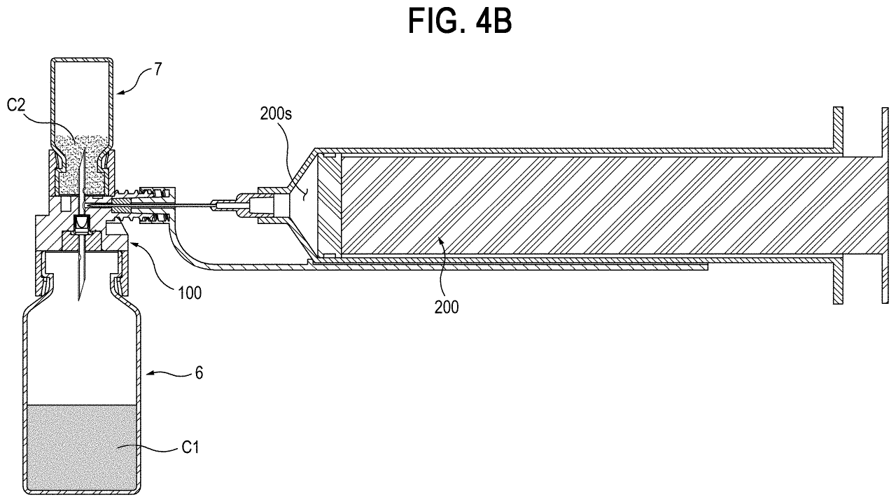

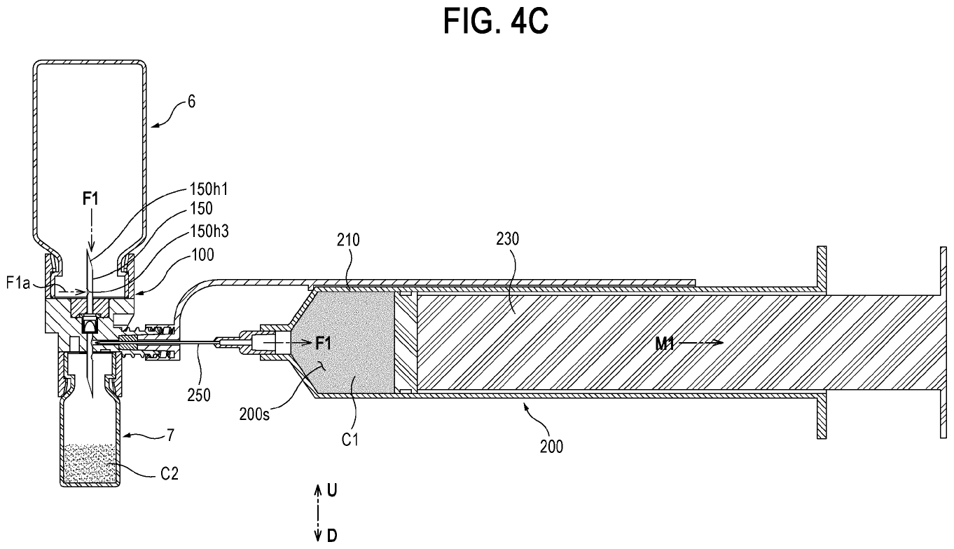

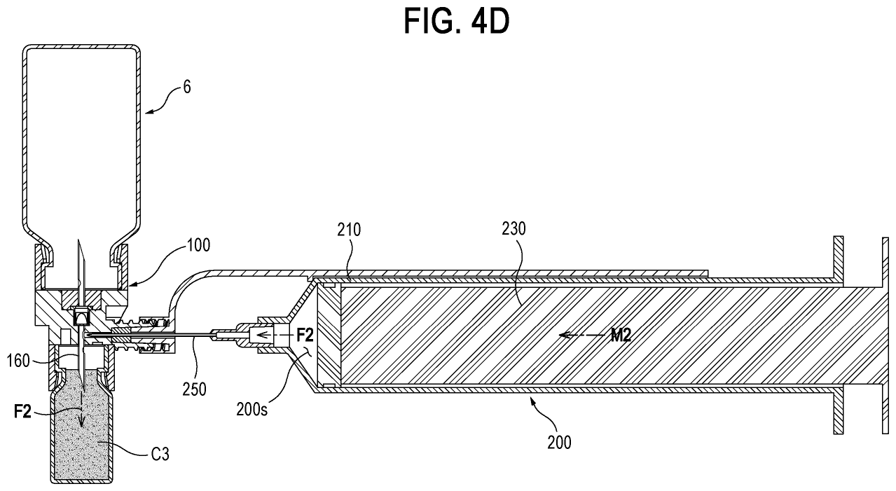

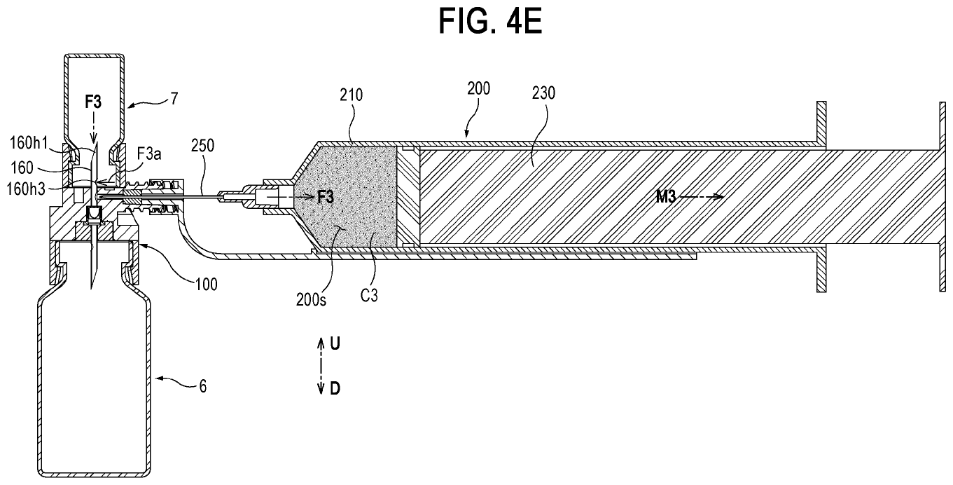

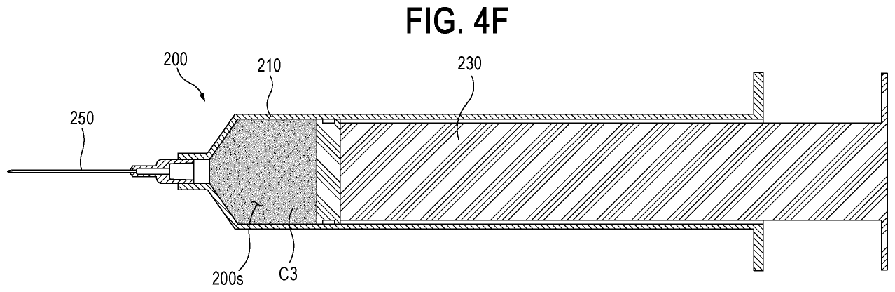

A hole (not illustrated) is formed at the protruding distal end of the protrusion 131. The hole in the protrusion 131 is formed to allow the liquid to pass therethrough. The hole in the protrusion 131 is opened or closed depending on the flow direction of the liquid in the first flow path Pa1. When the liquid in the first flow path Pa1 flows in the inflow direction F1, the hole in the protrusion 131 is opened (see FIG. 4C). The hole in the protrusion 131 is closed when there is no flow of the liquid in the first flow path Pa1 or when the liquid is about to flow in the outflow direction (see FIG. 4D).

The backflow prevention part 130 includes a seating portion 133 that is seated on the body 110. The seating portion 133 may be seated on the second part 110B. The seating portion 133 supports the protrusion 131. A hole may be formed in a center of the seating portion 133, and the liquid may move through the hole in the seating portion 133 to the hole in the protrusion 131.

For example, the protrusion 131 may be formed in a conical shape as a whole such that the vertex portion thereof protrudes. In this case, the hole in the protrusion 131 is formed in the vertex portion.

As another example, the protrusion 131 may include a first oblique surface extending to be inclined with respect to the protruding direction, a second oblique surface extending to be inclined in a direction opposite to the first oblique surface with respect to the protruding direction, and both side surfaces that cover the both sides of the first oblique surface and the second oblique surface. In this case, the first oblique surface and the second oblique surface meet while forming an edge at the protruding distal end of the protrusion 131, and the hole in the protrusion 131 extends lengthwise along the edge. When the liquid in the first flow path Pa1 flows in the inflow direction, the protruding distal end of the first oblique surface and the protruding distal end of the second oblique surface are bent in opposite directions to open the hole in the protrusion 131.

The drug mixing device 100 includes a first needle 150 protruding to be insertable into an interior of the first container 6. The first needle 150 may be formed in the form of an injection needle. The first needle 150 protrudes in the first direction D1. At the inlet of the first container 6, a film 6a made of a rubber material may be formed, and when the user couples the first container 6 to the drug mixing device 100, the first needle 150 may penetrate the film 6a.

The first needle 150 is fixed to the body 110. The first needle 150 may be fixed to the second part 110B. The first needle 150 may be fixedly inserted into the body 110. The first needle 150 defines therein at least a portion of the main flow path Pa. The first needle 150 may define therein a portion of the main flow path Pa located inside the body 110. The first needle 150 may form a portion of the main flow path Pa extending from the body 110 in the first direction D1. The first needle 150 forms the side of one end Q1 of the main flow path Pa.

The first needle 150 includes a pointed end 151 formed in the first direction D1 and a support end 152 formed on the opposite side to the pointed end 151. The support end 152 may be inserted into the body 110. A pointed end hole 150h1 is formed in the pointed end 151, and a support end hole (not illustrated) is formed in the support end 152. The first needle 150 defines therein a portion of the main flow path Pa connecting the pointed end hole 150h1 and the support end hole to each other.

The drug mixing device 100 includes a second needle 160 protruding to be insertable into an interior of the second container 7. The second needle 160 may be formed in the form of an injection needle. The second needle 160 protrudes in the second direction D2. At the inlet of the second container 7, a film 7a made of a rubber material may be formed, and when the user couples the second container 7 to the drug mixing device 100, the second needle 160 may penetrate the film 7a.

The second needle 160 is fixed to the body 110. The second needle 160 may be fixed to the first part 110A. The second needle 160 may be fixedly inserted into the body 110. The second needle 160 defines therein at least a portion of the main flow path Pa. The second needle 160 may define therein a portion of the main flow path Pa located inside the body 110. The second needle 160 may define therein a portion of the main flow path Pa extending from the body 110 in the second direction D2. The second needle 160 forms a side of the other end Q2 of the main flow path Pa.

The second needle 160 includes a pointed end 161 formed in the second direction D2 and a support end 162 formed on the opposite side to the pointed end 161. The support end 162 may be inserted into the body 110. A pointed end hole 160h1 is formed in the pointed end 161, and a support end hole (not illustrated) is formed in the support end 162. The second needle 160 defines therein a portion of the main flow path Pa connecting the pointed end hole 160h1 and the support end hole to each other.

In the present embodiment, the second needle 160 is inserted into the body 110 such that the support end 162 is positioned at a position beyond the connection point Q3 in the opposite direction to the second direction D2. The second needle 160 may define therein a flow path connection hole 160h4, which is opened in the extension direction of the branch flow path Pb at the connection point Q3. The main flow path Pa and the branch flow path Pb may communicate with each other through the flow path connection hole 160h4.

In another embodiment (not illustrated), the second needle 160 is fixed to the body 110 such that the support end 162 thereof is located at a position spaced apart from the connection point Q3 in the second direction D2. In this case, the flow path connection hole may not be formed.

At least one of the first needle 150 and the second needle 160 may define therein a remaining amount inflow hole 150h3 or 160h3 in a side surface at a position spaced apart from the corresponding pointed end 151 or 161. The drug mixing device 100 is configured to enable the liquid to be introduced into the main flow path Pa through the remaining amount inflow hole 150h3 or 160h3 from the interior of the container 6 or 7 into which the at least one of the needles 150 and 160 is inserted. In the present embodiment, the remaining amount inflow holes 150h3 and 160h3 are formed in the first needle 150 and the second needle 160, respectively. Through this, when the liquids inside the containers 6 and 7 are introduced into the main flow path Pa, the remaining amount of the liquids in the containers 6 and 7 can be reduced.

The drug mixing device 100 may include a sealer 180 disposed in the branch flow path Pb. In the present embodiment, the sealer 180 is disposed at the distal end of the branch flow path Pb. The sealer 180 is configured to be penetrated by the syringe needle 250. The sealer 180 may be formed of a silicon material. The user may separate the syringe 200 from the drug mixing device 100 by withdrawing the syringe needle 250 from the sealer 180.

The drug mixing device 100 may include a supporter 190 configured to support the syringe 200. The supporter 190 is coupled to the body. The supporter 190 may be fastened to the branch portion 116. The supporter 190 includes a body coupling part 195 coupled to the body 110. The body coupling part 195 may be coupled to the screw of the branch portion 116. A connection hole 190h through which the syringe needle 250 passes is formed in a center of the body coupling part 195. The connection hole 190h may penetrate the supporter 190 in the third direction D3. The connection hole 190h may face the sealer 180 in the third direction.

The supporter 190 includes a support surface 191 that forms a surface to come into contact with an outer surface of the syringe 200. For example, the support surface 191 may form an inner peripheral surface corresponding to an outer peripheral surface of the syringe. The support surface 191 may form an arc on a cross section perpendicular to the third direction D3. The support surface 191 extends in the third direction D3.

The supporter 190 includes a guide protrusion 192 protruding from the support surface 191 in the extension direction of the support surface 191. The guide protrusion 192 may guide the coupling and/or separation of the syringe 200 and the drug mixing device 100.

The supporter 190 includes a syringe engagement portion 193 configured to come into contact with and be engaged with the side surface of the syringe in the third direction D3. The syringe engagement portion 193 may protrude from the support surface 191. On the cross section perpendicular to the third direction D3, the syringe engagement portion 193 may extend along the support surface 191. A depth at which the syringe needle 250 is inserted into the branch flow path Pb may be limited by the syringe engagement portion 193.

The syringe 200 defines therein an inner space 200s communicating with the branch flow path Pb. The syringe 200 is configured to be capable of sucking the liquid from the branch flow path Pb into the inner space 200s. The syringe 200 is configured to be capable of discharging the liquid from the inner space 200s to the branch flow path Pb. The inner space 200s is a space that is capable of accommodating a liquid. A volume of the inner space 200s is changed by the relative motion of a plunger 230 with respect to the syringe housing 210, and thus the liquid is sucked into or discharged from the inner space 200s.

The syringe 200 includes a syringe flow path 200p connecting the branch flow path Pb and the inner space 200s to each other. The syringe needle 250 may define therein at least a portion of the syringe flow path 200p. The syringe hole 210a of the syringe housing 210 may define therein a portion of the syringe flow path 200p. In the state in which the syringe 200 and the drug mixing device 100 are coupled to each other, a portion of the syringe flow path 200p may be disposed in the branch flow path Pb.

The syringe 200 includes a syringe housing 210 that forms an exterior thereof. An inner space 200s is disposed in the syringe housing 210. A syringe hole 210a communicating with the inner space 200s is formed in the syringe housing 210. The syringe housing 210 includes a coupling part 211 coupled to the syringe needle 250. The syringe hole 210a may be disposed in a center of the coupling part 211. The syringe housing 210 includes a syringe body 213 extending in a cylindrical shape. The syringe housing 210 may include an engagement portion 215 protruding outward from the syringe body part 213 in a direction perpendicular to the third direction D3 to be engaged with a user's hand.

The syringe 200 includes the plunger 230 configured to be movable inside the syringe housing 210. The inner space 200s is partitioned by a pressing surface 231 of the plunger 230 and the inner surface of the syringe housing 210. The plunger 230 is configured to be movable in a discharge motion direction Dp1 in which the pressing surface 231 faces the inner space 200s and the inflow motion direction Dp2 opposite to the discharge motion direction Dp1.

The plunger 230 includes a gasket 232 that is in contact with the inner surface of the syringe housing. The plunger 230 includes a plunger body 235 to which the gasket 232 is fixed. The plunger body 235 extends to the outside of the opening of one side of the syringe housing 210. A manipulation portion 237 configured to be brought into contact and engaged with the user's hand is provided at the distal end of the plunger body 235 in the inflow motion direction Dp2.

The syringe 200 includes a syringe needle 250 configured to penetrate the sealer 180. The syringe needle 250 defines therein a flow path 200p configured to guide a flow of the liquid between the branch flow path Pb and the inner space 200s. The syringe needle 250 may protrude in the third direction D3 to form a pointed end. The syringe needle 250 includes a needle spike 251 configured to be insertable into a skin of a patient and a needle support 253 configured to support the needle spike 251. The needle support 253 is fixed to the syringe housing 210.

Meanwhile, a method for manufacturing the drug mixing device 100 (manufacturing method) may include a step of manufacturing the first connection part 111 and the second connection part 112 of the body 110. The first connection part 111 and the second connection part 112 may be manufactured according to the design content that meets product specifications. The first connection part 111 and the second connection part 112 may be injection-molded.

The manufacturing method may include a step of fixing the first connection part 111 and the second connection part 112 to the support part 115 (fixing step). The first connection part 111 and the second connection part 112 may be fixed to the support part 115 through a method such as laser bonding or ultrasonic bonding. By including the fixing step, it is possible to efficiently manufacture various types of drug mixing devices 100 by separately manufacturing the first connection part 111 and the second connection part 112 suitable for the shape or size of the first container 6 and the second container 7 to be coupled to the drug mixing device 100 and commonly producing the remaining portions of the body 110 including the support part 115.

FIGS. 4A to 4F are vertical cross-sectional views illustrating a drug mixing device 100, a syringe 200, the first container 6, and/or the second container 7 taken along line S1-S1′ in FIG. 1 and sequentially showing an example of using the drug mixing kit 1 of FIG. 1. Hereinafter, an example of use will be described in order with reference to FIGS. 4A to 4F.

Referring to FIG. 4A, the user prepares a drug mixing kit 1. As an example, the user may purchase a drug mixing kit 1 including a drug mixing device 100 and a syringe 200 coupled to each other. Thus, the user may prepare the drug mixing kit 1 without a separate operation of coupling the drug mixing device 100 and the syringe 200. As another example, the user may prepare the drug mixing kit 1 by purchasing each of the drug mixing device 100 and the syringe 200, and coupling the syringe 200 to the drug mixing device 100. In the latter case, the user may first couple the first container 6 and the second container 7 to the drug mixing device 100, and then couple the syringe 200 to the drug mixing device 100.

Referring to FIG. 4B, the user couples the first container 6 and the second container 7, each of which contains a medically necessary content, to the drug mixing device 100. The user couples, to the drug mixing kit 1, the first container 6 containing a first content C1 in a liquid form and the second container 7 containing a second content C2 in a liquid or powder form. Here, both ends of the main flow path Pa communicate with the interiors of the first container 6 and the second container 7, respectively.

Referring to FIG. 4C, the user holds the drug mixing kit 1 such that the first container 6 is disposed in the upward direction U and the second container 7 is disposed in the downward direction D. In this state, when the user increases the volume of the inner space 200s by moving the plunger 230 with respect to the syringe housing 210 in the inflow motion direction M1, the first content C1 in the first container 6 flows into the inner space 200s through the first flow path Pa1 and the branch flow path Pb (see arrow F1). Here, the first content C1 inside the first container 6 may be introduced into the main flow path Pa through the remaining amount inflow hole 150h3 (see arrow Fla). Here, the pressure inside the first container 6 may be lowered, and even if the user releases the plunger 230 pulled in the inflow motion direction M1, the first content C1 is prevented from returning to the interior of the first container 6 by the backflow prevention part 130.

Referring to FIG. 4D, when the user decreases the volume of the inner space 200s by moving the plunger 230 with respect to the syringe housing 210 in the discharge motion direction M2, the first content C1 in the inner space 200s flows into the second container 7 through the branch flow path Pb and the second flow path Pa2 (see arrow F2). Since the pressure inside the second container 7 is lowered in the process of FIG. 4C, even in the state in which the user removes the force pulling the plunger 230 or presses the plunger 230 with a small force, the first content C1 can flow into the second container 7. Here, even if the user moves the plunger 230 in the discharge motion direction M2 , the first content C1 is prevented from flowing into the first container 6 by the backflow prevention part 130. When the first content C1 flows into the second container 7, the user shakes the drug mixing kit 1 lightly to produce a mixture C3 of the first content C1 and the second content C2 in the second container 7.

Referring to FIG. 4E, the user holds the drug mixing kit 1 such that the second container 7 is disposed in the upward direction U and the first container 6 is disposed in the downward direction D. In this state, when the user increases the volume of the inner space 200s by moving the plunger 230 with respect to the syringe housing 210 in the inflow motion direction M3, the mixture C3 in the second container 7 flows into the inner space 200s through the second flow path Pa2 and the branch flow path Pb (see arrow F3). Here, the mixture C3 inside the second container 7 can flow into the main flow path Pa through the remaining amount inflow hole 160h3 (see arrow F3a).

Referring to FIG. 4F, after separating the syringe 200 from the drug mixing device 100, the user may pierce the patient's skin with the syringe needle 250 to inject the mixture C3 as a drug to the patient.

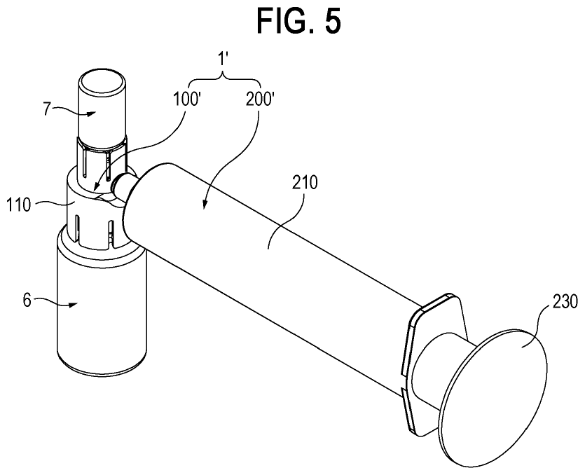

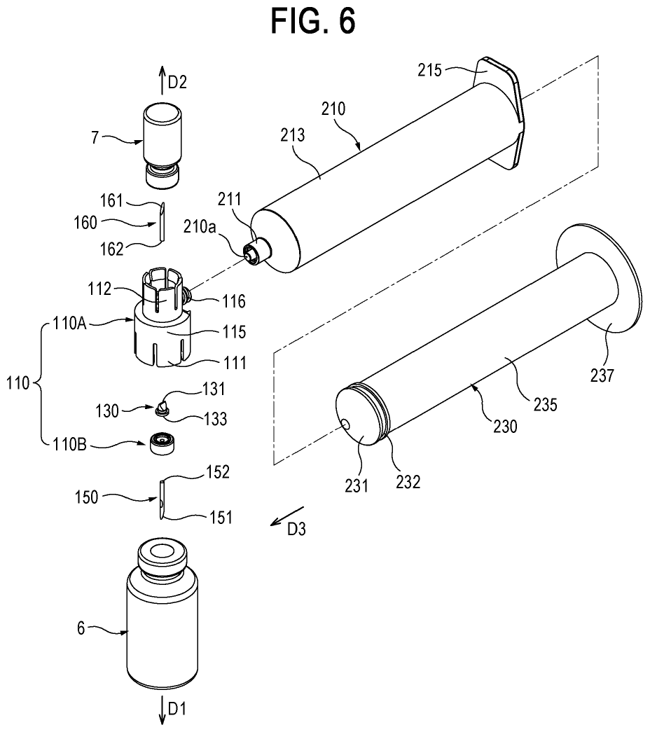

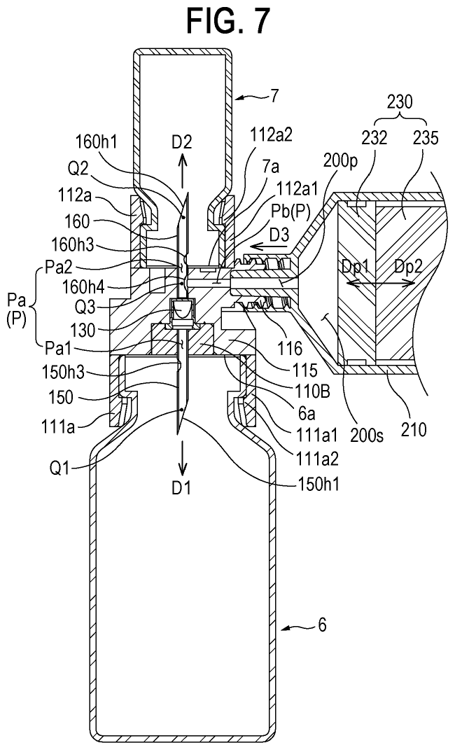

FIG. 5 is a perspective view illustrating the state in which a first container 6 and a second container 7 are coupled to a drug mixing kit 1′ according to a second embodiment of the present disclosure. FIG. 6 is an exploded perspective view illustrating the drug mixing kit 1′, the first container 6, and the second container 7 of FIG. 5. FIG. 7 is a partial vertical cross-sectional view illustrating the drug mixing kit 1′, the first container 6, and the second container 7 of FIG. 5, taken along line S1-S1′.

Hereinafter, focusing on the differences from the first embodiment described above, the drug mixing kit 1′, the drug mixing device 100′, and the syringe 200′ according to the second embodiment will be described with reference to FIGS. 5 to 7.

The drug mixing kit 1′ may include a drug mixing device 100′, which does not include the sealer and the supporter. The drug mixing kit 1′ may include a syringe 200′, which does not include the syringe needle.

The drug mixing device 100′ and the syringe 200′ are coupled to each other. The branch portion 116 of the drug mixing device 100′ and the coupling part 211 of the syringe 200′ are coupled to each other. In the second embodiment, the branch portion 116 and the coupling part 211 may be screw-fastened to each other. After filling the inner space 200s of the syringe 200′ with the mixture C3 and then separating the syringe 200′ from the drug mixing device 100′, the user may couple a separate device for drug injection into the patient, such as a catheter or an injection needle, to the syringe 200′.

The technical idea of the present disclosure has been described heretofore with reference to some embodiments and examples shown in the accompanying drawings. However, it is to be understood that various substitutions, modifications and alterations may be made without departing from the technical idea and scope of the present disclosure that can be understood by those of ordinary skill in the technical field to which the present disclosure pertains. Further, it is to be understood that such substitutions, modifications and alterations fall within the scope of the appended claims.

1. A drug mixing device for mixing a first content in a liquid form in a first container and a second content in a liquid or powder form in a second container, in which a main flow path extending from one end configured to allow a liquid inside the first container to flow into the main flow path therethrough to other end configured to allow a liquid inside the second container to flow into the main flow path therethrough, and a branch flow path branching from the main flow path are formed,
wherein the main flow path includes, with reference to a connection point of the main flow path and the branch flow path, a first flow path extending while connecting the one end to the connection point and a second flow path extending while connecting the other end to the connection point,
the drug mixing device comprises:
a body including a first connection part configured to be coupled with the first container and a second connection part configured to be coupled with the second container; and
a backflow prevention part disposed in a partial flow path of the main flow path extending in a direction of the one end with reference to the connection point of the main flow path and the branch flow path, the backflow prevention part being configured to prevent the liquid from flowing from the connection point to the one end while allowing the liquid to flow from the one end to the connection point,
in a state in which the first container, the second container, and a syringe including an inner space communicating with the branch flow path are coupled to the drug mixing device, the first content in the first container flows into the inner space via the first flow path and the branch flow path and then the first content in the inner space flows into the second container via the branch flow path and the second flow path to allow the first content in the first container to flow into the second container, and
when the first content flows into the inner space, a pressure inside the first container and a pressure inside the second container are lowered.

2. The drug mixing device of claim 1, wherein the first connection part includes a plurality of hooks configured to be engaged with the first container,
the second connection part includes a plurality of hooks configured to be engaged with the second container, and
the body includes a support part configured to support the first connection part and the second connection part.

3. The drug mixing device of claim 2, further comprising:
a first needle forming a side of the one end of the main flow path and protruding to be insertable into an interior of the first container; and
a second needle forming a side of the other end of the main flow path and protruding to be insertable into an interior of the second container,
wherein the plurality of hooks of the first connection part are arranged to be spaced apart from each other in a circumferential direction around the first needle, and
the plurality of hooks of the second connection part are arranged to be spaced apart from each other in a circumferential direction around the second needle.

4. The drug mixing device of claim 1, wherein the body further includes a branch portion forming at least a portion of the branch flow path configured to discharge the liquid into the syringe.

5. The drug mixing device of claim 1, wherein the body further includes a branch portion configured to be connectable to the syringe that defines therein the inner space communicating with the branch flow path.

6. The drug mixing device of claim 1, further comprising:
a first needle forming a side of the one end of the main flow path and protruding to be insertable into an interior of the first container; and
a second needle forming a side of the other end of the main flow path and protruding to be insertable into an interior of the second container.

7. The drug mixing device of claim 6, wherein the first needle and the second needle are fixed to the body.

8. The drug mixing device of claim 6, wherein the body includes a first part in which the backflow prevention part is disposed, the first needle being fixed to the first part, and
a second part coupled to the first part while covering the backflow prevention part, the second needle being fixed to the second part.

9. The drug mixing device of claim 6, wherein at least one needle of the first needle and the second needle defines therein a remaining amount inflow hole in a side surface at a position spaced apart from a pointed end thereof, and
the drug mixing device is configured to enable the liquid to flow into the main flow path from an interior of a container, into which the at least one needle is inserted, through the remaining amount inflow hole.

10. The drug mixing device of claim 1, further comprising:
a sealer disposed in the branch flow path and configured to be penetrated by a syringe needle.

11. The drug mixing device of claim 1, further comprising:
a supporter coupled to the body and configured to support the syringe.

12. A method of manufacturing the drug mixing device of claim 2, the method comprising:
fixing the first connection part and the second connection part to the support part.

13. A drug mixing kit for mixing a first content in a liquid form in a first container and a second content in a liquid or powder form in a second container, the drug mixing kit comprising:
a drug mixing device in which a main flow path extending from one end configured to allow a liquid inside the first container to flow into the main flow path therethrough to other end configured to allow a liquid inside the second container to flow into the main flow path therethrough and a branch flow path branching from the main flow path are formed; and
a syringe coupled to the drug mixing device and including an inner space communicating with the branch flow path, the syringe being configured to suck a liquid from the branch flow path into the inner space and discharge the liquid from the inner space into the branch flow path,
wherein the main flow path includes, with reference to a connection point of the main flow path and the branch flow path, a first flow path extending while connecting the one end to the connection point and a second flow path extending while connecting the other end to the connection point,
the drug mixing device includes:
a body including a first connection part configured to be coupled with the first container and a second connection part configured to be coupled with the second container; and
a backflow prevention part disposed in a partial flow path of the main flow path extending in a direction of the one end with reference to the connection point of the main flow path and the branch flow path, the backflow prevention part being configured to prevent the liquid from flowing from the connection point to the one end while allowing the liquid to flow from the one end to the connection point,
in a state in which the syringe, the first container, and the second container are coupled to the drug mixing device, the first content in the first container is caused to flow into the inner space via the first flow path and the branch flow path by increasing a volume of the inner space and then the first content in the inner space is caused to flow into the second container via the branch flow path and the second flow path by decreasing the volume of the inner space to allow the first content in the first container to flow into the second container, and
when the first content flows into the inner space, a pressure inside the first container and a pressure inside the second container are lowered.

14. The drug mixing kit of claim 13, wherein the drug mixing device and the syringe are detachably coupled to each other.

15. The drug mixing kit of claim 13, wherein the drug mixing device further includes a sealer disposed in the branch flow path, and
the syringe includes a syringe needle configured to penetrate the sealer and define therein a flow path to guide a flow of the liquid between the branch flow path and the inner space.
